(19) United States
(12) Patent Application Publication
(10) Pub. No.: US 2008/0208719 A1
(43) Pub. Date: Aug. 28, 2008

(54) Expert system for optimization of retail shelf space

(75) Inventors: Chaitanya Kumar Sharma, Cupertino, CA (US); Cordell BaanHofman, Littleton, CO (US)

Correspondence Address: MERCHANT & GOULD PC, P.O. BOX 2903, MINNEAPOLIS, MN, 55402-0903, US

(73) Assignee: Fair Isaac Corporation, Minneapolis, MN (US)

(21) Appl. No.: 11/712,780

(22) Filed: Feb. 28, 2007

(51) Int. Cl. G06F 17/50

(52) U.S. Cl. 705/29; 700/30; 700/32

(57) ABSTRACT

A business rules engine works with an optimization engine through various user interfaces to facilitate increased efficiency in retail space planning. Rules and models are built from templates that are stored in a repository. Business analysts and retail space planners both have access to the repository to develop models and rules. A project consists of a selection of rules and models from the repository along with selected data from various data sources. A scenario is created for the project by specifying constraints, parameters, and optimization objectives. The optimization engine processes the scenario and attempts to find an optimum solution. when a perfect solution (100%) cannot be found, the optimization engine evaluates the various criteria in the scenario and relaxes requirements until an acceptable solution is found. The output of the optimization engine can automatically be provided as graphical visualizations such as plan-o-grams, graphs, charts, and other forms.

### FIELD OF THE INVENTION

The present invention relates generally to systems, methods and processes for managing retail space. More particularly, the present invention relates to a system and method for managing retail space by combining the use of business rules with an optimization engine.

### BACKGROUND OF THE INVENTION

Managing shelf space is critical for retailers to attract customers and to optimize profit. Many retailers struggle with their decisions of which products to stock among the large number of competing products and how much shelf space to allocate to those products. Because shelf space is a scarce and fixed resource and the number of potentially available products continually increases, retailers have a high incentive to make these stocking decisions carefully.

Poorly allocated retail shelf space may result in lost sales and lost revenues. When customers are completely brand-loyal, they would look for a specific item and buy it if it when available or delay their purchasing decisions when the specific item is out-of-stock. In such an instance the retail space that is allocated for a product has no effect on its sales. However, marketing research indicates that most customer decisions are made at the point-of-purchase. Except in relatively short time periods, buyers of any particular brand may buy other brands more often than their preferred brand. This indicates that the product choice of many consumers may be influenced by in-store factors including shelf space allocated to a product.

The present disclosure contemplates the above described factors and others to facilitate well-designed retail shelf space. Discussed further herein, the described methods can assist retailers in attracting customers, preventing stock-outs and increasing the financial performance of the store while reducing operating costs. Furthermore, the presently disclosed systems, methods, and processes may be utilized to achieve close-to-optimal shelf space allocations such that promotional resources are easily distributed among different product categories. As described in further detail below, the optimization problem for retail space management can be very complex since many products have different profit margins, widely varying retail space requirements, and differing cross-elasticities,

### SUMMARY OF THE INVENTION

A system and method are related to a business rules engine that works with an optimization engine through various user interfaces to facilitate increased efficiency in retail space planning. Rules and models are built from templates that are stored in a repository. Business analysts and retail space planners both have access to the repository to develop models and rules. A project consists of a selection of rules and models from the repository along with selected data from various data sources. A scenario is created for the project by specifying constraints, parameters, and optimization objectives. The optimization engine processes the scenario and attempts to find an optimum solution. When a perfect solution (100%) cannot be found, the optimization engine evaluates the various criteria in the scenario and relaxes requirements until an acceptable solution is found. The output of the optimization engine can automatically be provided as graphical visualizations such as plan-o-grams, graphs, charts, and other forms.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS

FIG. 1 is a diagram illustrating a high-level view of a system arranged in accordance with the present disclosure.

FIG. 2 is a diagram illustrating the functional relationship between various components in a system arranged in accordance with the present disclosure.

FIG. 3 is a diagram illustrating a process flow for a retail space management system arranged in accordance with the present disclosure.

FIG. 4 is a flow chart for a space planning application arranged in accordance with the present disclosure.

FIG. 5 is a flow chart for a process to build a base model in accordance with the present disclosure.

FIG. 6 is a flow chart for a process to solve a scenario in accordance with the present disclosure.

FIGS. 7A-7C are illustrations of a user interface including output visualizations for a retail space management system that is arranged in accordance with the present disclosure.

FIG. 8 is an illustration of a user interface including facility for designing inventory rules for a retail space management system that is arranged in accordance with the present disclosure.

FIG. 9 is an illustration of another user interface including facility for designing inventory rules for a retail space management system that is arranged in accordance with the present disclosure.

### DETAILED DESCRIPTION OF THE PREFERRED EMBODIMENT

The present disclosure is described in the context of systems and methods for managing retail space. The described systems and methods may be employed by user interfaces and processes for managing the design and layout of retail space including, but not limited to, store level space planning, adjacency level space planning, and shelf level space planning. Store level space planning is generally described as the process for allocation of retail space with related fixtures to design space for super-categories based for the overall store layout. Adjacency level space planning (aka macro space planning) is generally described as the process for allocation of retail merchandising space with related fixtures according to adjacency relationships between different categories or sub-groups. Shelf level space planning (aka micro space planning) is generally described as the process for allocation of retail shelf space according to products, product groups, and product brands, including the process for building plan-o-grams (POGs) to visualize the final shelf space.

Studies have indicated that customers buying behavior is impacted by the general layout of the store and how much retail space is allocated to a particular product. Retailers put a large amount of time and effort into deciding which products to put on their shelves and where to place those products. Such retailers often rely on industry knowledge and manual techniques to design and manage such things grouping products together according to commonly known categories (e.g., electronics, appliances, sporting goods, bedding, cereals, etc.), and shelf space design using conventional plan-o-gram (POG) techniques.

Retailers often track product sales, inventory, profits and other information to aide decision makers in designing and allocating retail space. Conventional wisdom states that the best use of retail shelf space is to optimize profitability by placing items that are most profitable into the largest number of places of the store. By increasing the likelihood of a buyer discovering such a product, profits are expected to increase for the store. Other consideration may include decisions on how much space to allot for potentially available products, decisions on products that attract customers, decisions on inventory to prevent stock, and other decisions that may increase the financial performance of the store while reducing operating cost.

Some conventional tools are available to provide visualization of prospective designs of retail shelf space. These tools are operated by space planners that utilize their own industry know how to make decisions on product selections and overall layout. However, the number of factors that can be considered in managing retail space is too great for a human to arrive at an optimal solution. For example, retail space planning requires consideration of numerous factors such as product package dimensions, profit per package, number of product facings, groupings of products by brand, number of products in a category, historical sales for products, predicted future sales for products, selling price of products, unit cost of product, restocking constraints and fees, out of stock penalties, as well as numerous other upper and lower bound variables. The skills and expertise that are heavily relied upon in retail space planning are often lost when the space planner moves on to other opportunities.

The present disclosure considers all of the above described factors and others in presenting a complete solution for retail management. Interactive space planning and optimization is facilitated by a business rules management (BRM) interface that space planners and analysts can both use. Space planners and analysts both have access to an optimization engine that performs optimization of multiplicity of objectives by applying mathematical models with predictive analytics together with business rules. Business rules, constraints, parameters and optimization objectives can be defined, imported and modified using an interactive user interfaces. A Business Rule Management (BRM) interface that permits the user to simply modify the optimization criteria using what-if scenarios. After parsing all inputs for the defined scenario, optimization methods are applied and visualizations can be automatically generated. The visualizations can take on a variety of forms including graphs, charts, and other forms that are useful for analysts in evaluating business impact. The visualizations can also take on the form of a plan-o-gram (POG) that illustrates the layout of the retail space including other information that is useful to space planners.

### System Overview

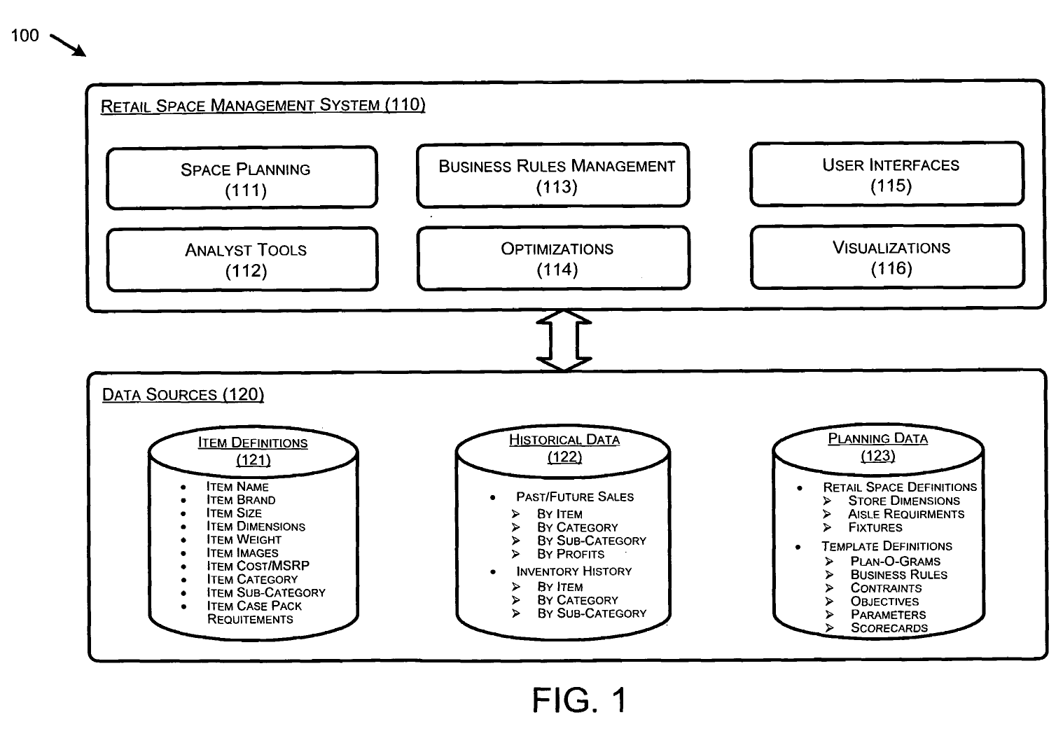

FIG. 1 is a diagram illustrating a high-level view of a system (100) arranged in accordance with the present disclosure.

System 100 includes a retail space management system (110) and a set of data sources (120). The retail space management system (110) includes functional modules for space planning (111), analyst tools (112), business rules management or BRM (113), optimization (114), user interfaces (115) and visualizations (116). The retail space management system (110) is arranged to interact with a combination of internal and external data sources. Internal data sources such as enterprise wide data sources can be accessed natively by the system. External data sources can be accessed through import functions as well as other data access facilities. Example data sources (120) include item definitions (121), historical data (122) and planning data (123), to name a few.

The space planning module (111) includes applications and methods that are useful for space planners in managing retail floor space on a macro level and a micro level by category, sub-category, etc. The analyst tools module (112) includes applications and methods that are useful for business analysts for evaluating product sales related information on every level (e.g., global sales, regional sales, store sales, product sales, etc.) such as may be useful for forecasting, resource allocation, demand planning, product category management, and retail price optimization. The BRM module (113) includes applications and methods that are useful for creating, editing, deleting, and otherwise manipulating business rules. The optimization module (114) includes applications and methods that are arranged to apply search criteria to selected data to find a retail space management solution that optimally or nearly optimally satisfies the search criteria. The user interfaces module (115) includes applications and methods that are useful for simplifying data entry and selection of various parameters and user inputs for the other modules. The visualizations module (116) includes applications and methods that are useful for processing output data from other modules for presentation to the user in a format that is useful in business analysis, macro-space planning and micro-space planning for retail space management applications.

Item definitions (121) include various types of information that is related to the storage, sales and management of retail products, including but not limited to item name, item brand, item size (e.g. size 9 shoe), item dimensions, item weight, item image (a visualization aide), item cost, item MSRP, item category (e.g., sporting goods, electronics, etc.), item sub-category (e.g., snow sports gear), and item case pack requirements (e.g., 24 items per case). Historical data (122) includes various type of information that is related to sales histories and inventory histories, which are useful for analyzing profits, losses, stocking, restocking, and other related issues. Historical data (122) can include additional information related to sales histories and inventory histories so that such information can be organized by item, by category, by sub-category, by profit, etc. Planning data (123) includes retail space definitions and template definitions. Retail space definitions includes information that is related to the retail stores themselves, such as the dimensions of the store, the aisle requirements for the store, fixtures that are used in the store, etc. Template definitions include templates for plan-o-grams, business rules, constraints, objectives, parameters, and scorecards.

Although depicted in FIG. 1 as separate functional modules, the functions associated with each individual module can be separated or combined into any number of other modules without departing from the spirit of the present disclosure. In some examples implementations, functional modules are arranged as separate procedures that pass parameters between one another via variables, data structures, and procedure calls. In other example implementations, functional modules are interoperable with one another through an application programming interface (API). In still other examples, functional modules are interoperable with one another through a binary interface.

Although the data sources (120) depicted in FIG. 1 are illustrated as separate data sources (121, 122, 123), the associated data can be separated or combined into any number of other logically or physically partitioned data stores without departing from the spirit of the present disclosure. The data itself can of any relevant form that is accessible from a data source (e.g., a database) such as a database entry, a Lightweight Directory Access Protocol (LDAP) entry, a text document, a HyperText Markup Language (HTML) document, an Extensible Markup Language (XML) document, a graphical image (e.g., binary or compressed such as GIF, JPEG, etc.), a Java object, etc.

### Functional Overview

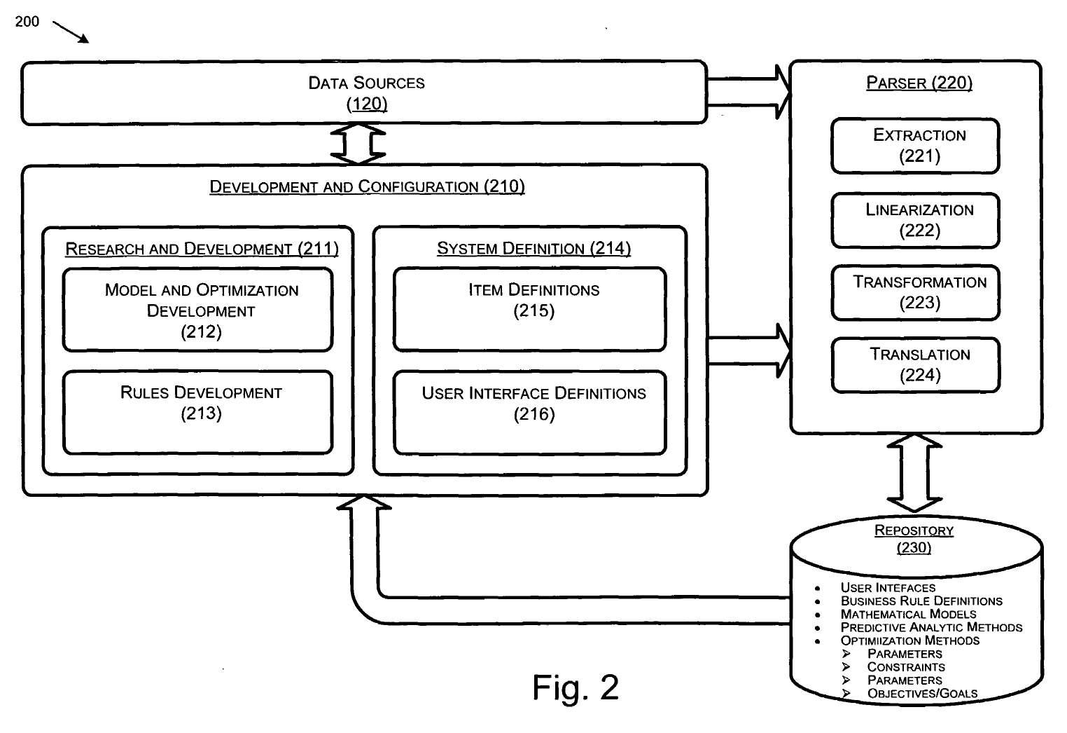

FIG. 2 is a diagram illustrating the functional relationship between various components in a system (200) arranged in accordance with the present disclosure. System 200 includes functional blocks for development and configuration (210), data sources (120), a parser (220), and a repository (230).

Example data sources (120) include item definitions (121), historical data (122) and planning data (123), such as that previously described above. The repository (230) is a data store that is arranged to store therein any variety of rules, models, and methods. By way of example, the repository (230) can include business rule definitions, mathematical models, predictive analytic methods, and optimization methods.

The development and configuration functional block (210) can be partitioned into functional blocks for research and development (211) and system definition (214). The research and development block (211) includes facility for model and optimization development (212), and rules development (213). The system definition block (214) includes facility for item definitions (215) and user interface definitions (216).

The research and development block (211) can utilize resources from the data sources (120) and the repository (230) to design and develop additional rules and methods that can be stored in the repository (230) after being processed by the parser (220). The system definition block (214) can be used for entering data such as item definitions (121), historical data (122) and planning data (123), which can be stored in the data sources (120), and also to define user interfaces that can be stored in the repository (230). Developers can also utilize the various resources from the development and configuration functional block (210) to create Rule Maintenance Applications such as using highly customized Web forms and other types of interfaces.

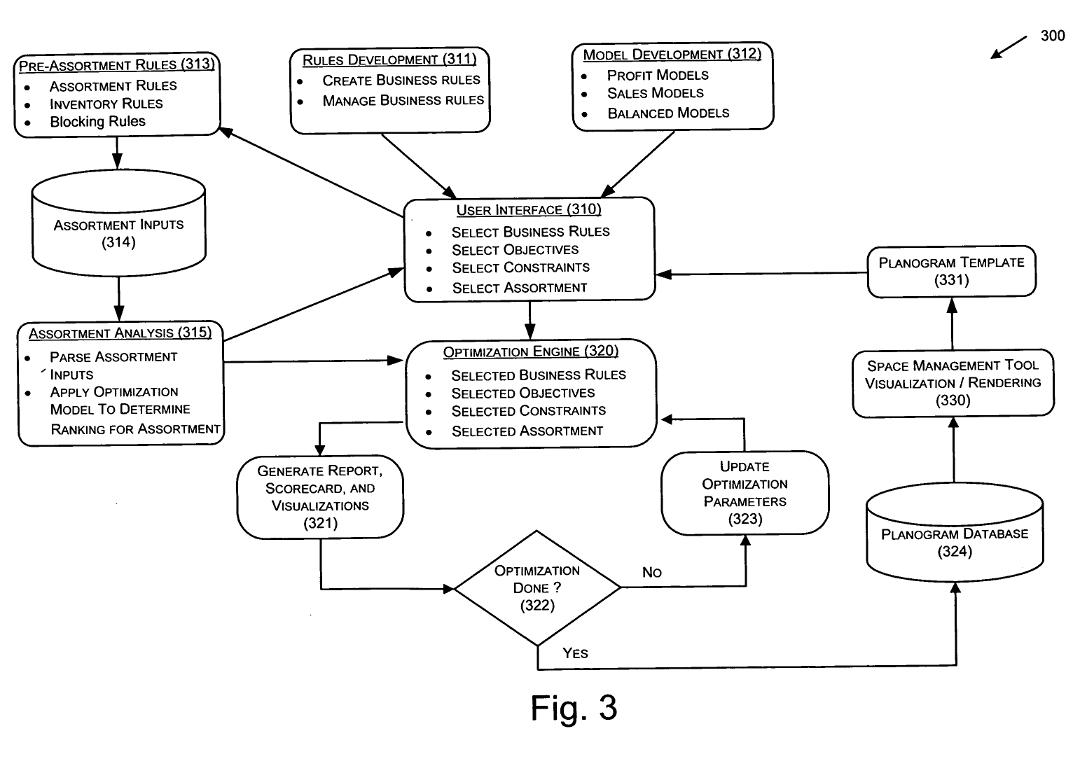

The parser (220) includes functional blocks for extraction (221), linearization (222), transformation (223) and translation (224). The extraction block (221) is arranged to extract data that is received from an external data source or an internal data source and format the data for use and storage in the present system. The extraction block (221) is also arranged to extract information about user interface definitions, models, and business rules from templates and other sources so that variables and parameters can be identified for those definitions and stored in the repository (230). The linearization block (222) is arranged parse methods and model definitions so that they can be formatted into a linear program. The transformation block (223) is arranged to evaluate mathematical models and rules and then translate those mathematical models and rules into a language that is acceptable by an optimization engine (not shown, see discussion for FIG. 3). The translation block (224) is arranged to translate business rules into a solvable mathematical formula representation, and also identify variables associated with those business rules.

Business rule definitions that are stored in the repository (230) can be formulated in a Structured Rule Language (SRL) that uses Boolean style logical operators in an English-like fashion. Alternatively, business rule definitions can be generated using sophisticated ruleset metaphors that are used by non-programmers such as via decision tables, decision trees and scorecards. The Mathematical models stored in the repository (230) can be formulated as interpreted or compiled modules that are arranged to perform any desired mathematical operation on data including linear functions, non-linear functions, statistical functions, limiting functions, and transformations, to name a few. Predictive analytic methods are those methods that employ statistical models and data mining methods to process current and historical data in order to make “predictions” about future events. Optimization methods are those methods that search through data to locate maximal or minimal solution as defined by search criteria. Each optimization method can be implemented as a mixed integer program (MIP). The search criteria employed by the optimization method can include constraints, parameters, and optimization objectives or goals. The optimization method is bounded by the defined constraints, which limits the logical output of the model, and the parameters which create a physical boundary for the solution such as shelf length, width, etc.

The models, methods, rules, and user interfaces stored in the repository (230) can be utilized by business analyst users and retail space management users alike. This enables developers to work in a coordinated manner as teams that leverage each other's work by sharing and reusing rules, rule sets, rule flows and object models. The rule repository can be stored as an XML file, database or LDAP directory.

### Illustrative Process Flow/System

FIG. 3 is a diagram illustrating a process flow for a retail space management system (300) arranged in accordance with the present disclosure. The retail space management system (300) includes a user interface (310), an optimization engine (320), and a space management tool with visualization/rendering capabilities (330).

The user interface (310) is arranged to provide a convenient interface for selection of a what-if scenario for optimization by the optimization engine (320). The scenario is comprised of one or more business rules that are applied to data that can be limited by context through a series of selected constraints and/or item assortments. For example, a business rule for “minimum number of days of supply for item X” can be constrained to 3 days, while another business rule for “maximum number of days of supply for item X” can be constrained to 7 days. The scenario can thus be defined to require item X in the product assortment where upper and lower bounds for the number of days of supply constrain the solution to the problem.

The business rules that are selected by the user interface (310) can be retrieved from the repository (e.g., see FIG. 2). Alternatively, the business rules can be selected created and managed from a rules development interface (311). The user interface (310) also permits the selection of an assortment of items from data sources for consideration by the selected business rules, and selection of an optimization objective or goal. Based on the selected objectives and business rules, various models are retrieved from the repository. Alternatively, the models can be created and managed from a model development interface (312). Models can be profit models, sales modes, and other balanced models that attempt to balance objectives such as sales, profits, inventory management, and well as other objectives.

The selected objectives, business rules, objectives and assortment of items from the data sources are submitted to the optimization engine (310) as a scenario. The optimization engine applies the necessary rules and models to the selected assortment to attempt to achieve a solution that is acceptable to the user. The optimization engine (320) has the ability to cope with competing objectives where no perfect (i.e. 100%) solution is available do to the particulars of the selected constraints on the selected business rules for the selected assortment. The optimization engine (310) is thus arranged to find a linear solution to the retail space planning problem using Mixed Integer Programming (MIP), where the constraints are selectively relaxed to find an acceptable solution.

The optimization engine (320) generates output that is used to generate a report such as a scorecard including visualizations (321). In some examples, the generated report includes a list of objectives and rules with constraints that could not be satisfied. In other examples, the generated giving a score or rating indicating the percentage of objectives for which a solution was successfully found. After the user reviews the generated report, the user can decide weather or not additional optimizations need be done at decision block 322.

The optimization criteria can be updated at block 323 and resubmitted to the optimization engine to again attempt to find an optimal solution. In some instances, blocks 321-323 can be handled by the system without user interaction so that the optimization engine can automatically attempt to relax various optimization criteria to achieve a solution.

When optimization is complete, the scenario along with the various optimization criteria and visualization data is stored in a database such as a plan-o-gram database (324). The output of the plan-o-gram database is provided to a space management tool that includes visualization and rendering facilities to present a graphical output to the use (e.g., a detailed plan-o-gram of the solution). The rendered solution is then saved as a plan-o-gram template at block (331), which is presented to the user interface (310).

Various rules can be extracted from the plan-o-gram template such as blocking rules, fixture rules, product sequences, etc. These extracted rules can be presented to the user for further consideration and refined selection of a space planning solution.

The user interface (310) can be used for identification of pre-assortment rules (313). Pre-assortment rules (313) include assortment rules, inventory rules and blocking rules and item rules. Assortment rules can be used to define complementary products, item ranking criteria based on sales and/or profits, define inventory coverage, define private label (Market Pantry) coverage, and define an assortment decision tree to establish hierarchies for items. Inventory rules can be used to define case pack requirements, days of supply requirements, minimum number of product facings, maximum number of product facings, and conflict resolution criteria for conflicting inventory rules. Blocking rules can be used for brand blocking, where a brand block restricts a contiguous block of shelf space to a particular brand, or for item-shelf affinity where an item of a particular size is suited for a particular sized shelf space.

Pre-assortment rules are stored as assortment inputs in a data store (314), which is then accessed for assortment analysis (315). During assortment analysis (315), the assortment inputs are parsed and an optimization model is used by the optimization engine to determine rankings for the assortment. The assortment is then accessible by the user interface (310).

### Micro-Space Planning Process Flow

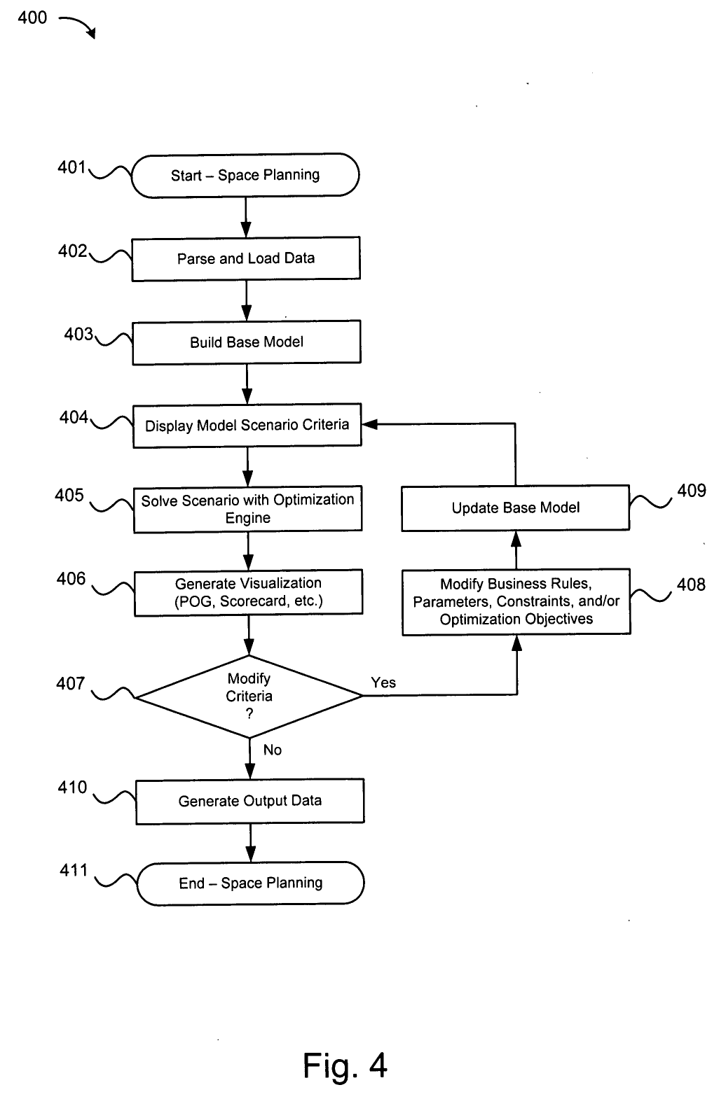

FIG. 4 is a flow chart (400) for a space planning application arranged in accordance with the present disclosure.

Processing for space planning begins at block 401 and flows to block 402, where data is parsed and loaded into the system. At block 403 the base model is built from a core model using various constraints, parameters, and objectives. Continuing to block 404 the model scenario criteria is displayed to the user. At block 405 the scenario is solved such as by submitting the constraints, parameters and objectives to the optimization engine. At block 406 visualizations are generated such as a plan-o-gram, scorecard, graph, chart, report or other visual aide. Continuing to decision block 407, the user views the results for the scenario and determines if the scenario criteria needs to be modified. Processing continues from decision block 407 to block 408 when additional criteria are to be modified, where the user can modify any available business rules, parameters, constraints, and/or optimization objectives. From block 408, processing continues to block 409 where the base model is appended creating a history of scenarios and results. Processing returns back to block 404 from block 409. Processing continues from decision block 407 to block 410, when no additional criteria are to be modified. At block 410, output data is generated for the solution that has been found by the optimization engine. Processing then terminates at block 411.

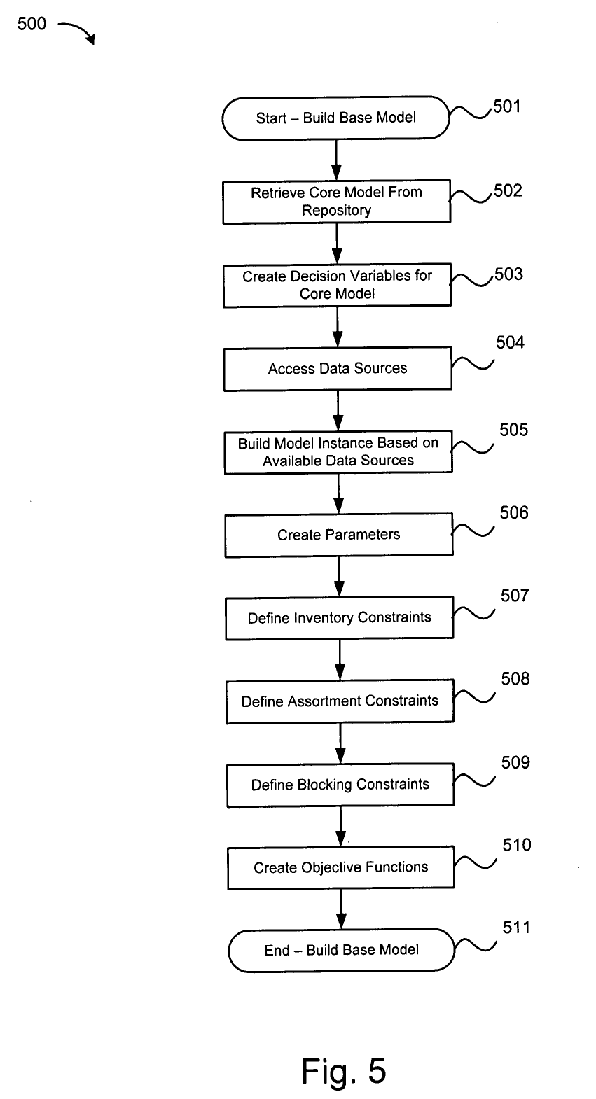

FIG. 5 is a flow chart (500) for a process to build a base model in accordance with the present disclosure.

Processing for building a base model begins at block 501 and flows to block 502, where a core model is retrieved from the repository. At block 503 decision variables are created for the core model. Proceeding to block 504, data sources are accessed for the core model, including any available data sources such as item definitions, historical data, planning data, etc. At block 505 a model instance is built from the retrieved core model based on the data that is available from the data sources. Continuing to block 506, parameters are created for the model instance. At block 507 inventory constraints are defined for the model instance. At block 508 assortment constraints are defined for the model instance. At block 509 blocking constraints are defined for the model instance. At block 510 objectives functions are created for the goal associated with the current optimization criteria. Processing then terminates at block 511.

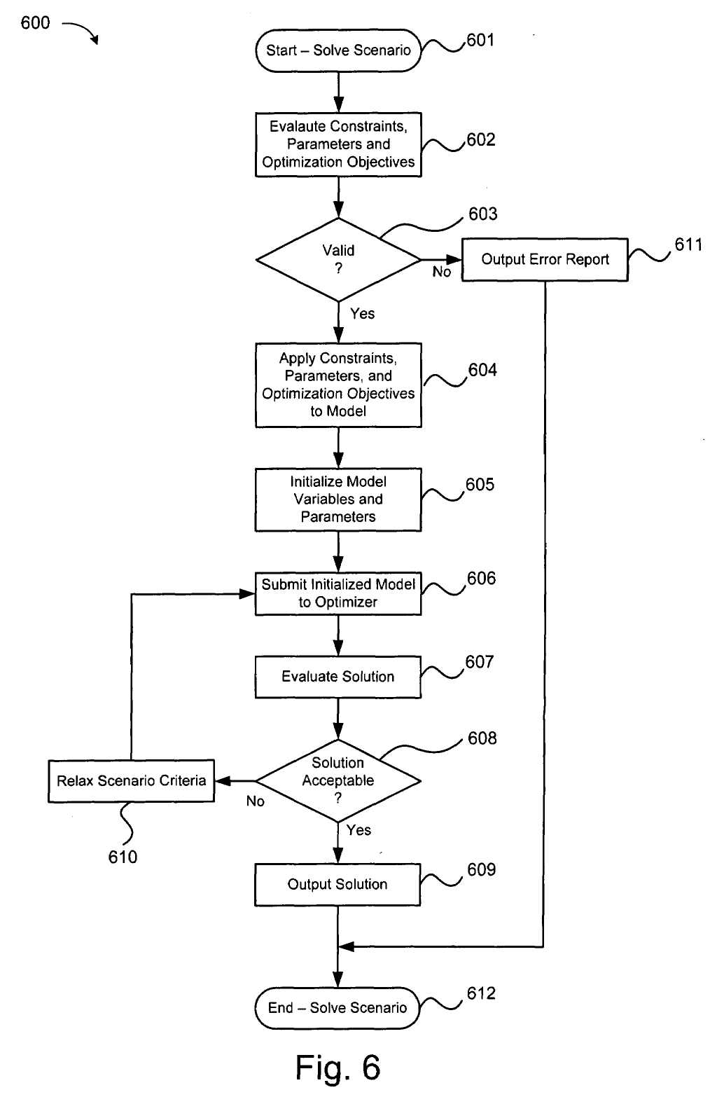

FIG. 6 is a flow chart (600) for a process to solve a scenario in accordance with the present disclosure.

Processing for solving the scenario begins at block 601 and flows to block 602, where constraints, parameters, and optimization objectives are evaluated. Processing continues from block 602 to decision block 603, which determines if the various criteria are valid. Processing flows from decision block 603 to block 604 when the criteria is valid, or to block 611 when the criteria is valid. At block 611, an error report is output and processing is terminated at block 912.

At block 604 the constraints, parameters, and optimization objectives are applied to the model instance. Continuing to block 605, model variables and model parameters are initialized. At block 606 the initialized model instance is submitted to the optimizer to find a solution. Flowing to block 607, the solution from the optimizer is evaluated. Decision block 608 determines if the solution is acceptable. Processing flows from decision block 608 to decision block 610 when the solution is unacceptable, or to block 609 when the solution is acceptable. At block 610, the scenario criteria is relaxed, and processing continues to block 606. At block 609 the solution is output, and processing terminates at block 912.

Example User Interface Illustrations

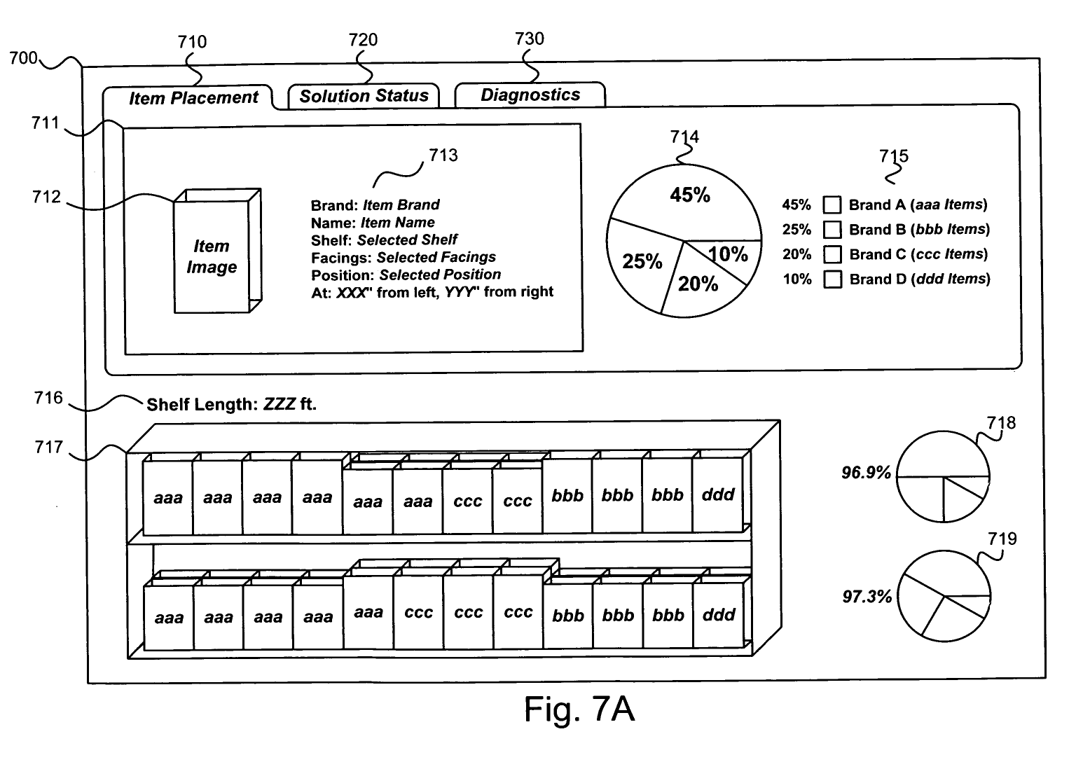

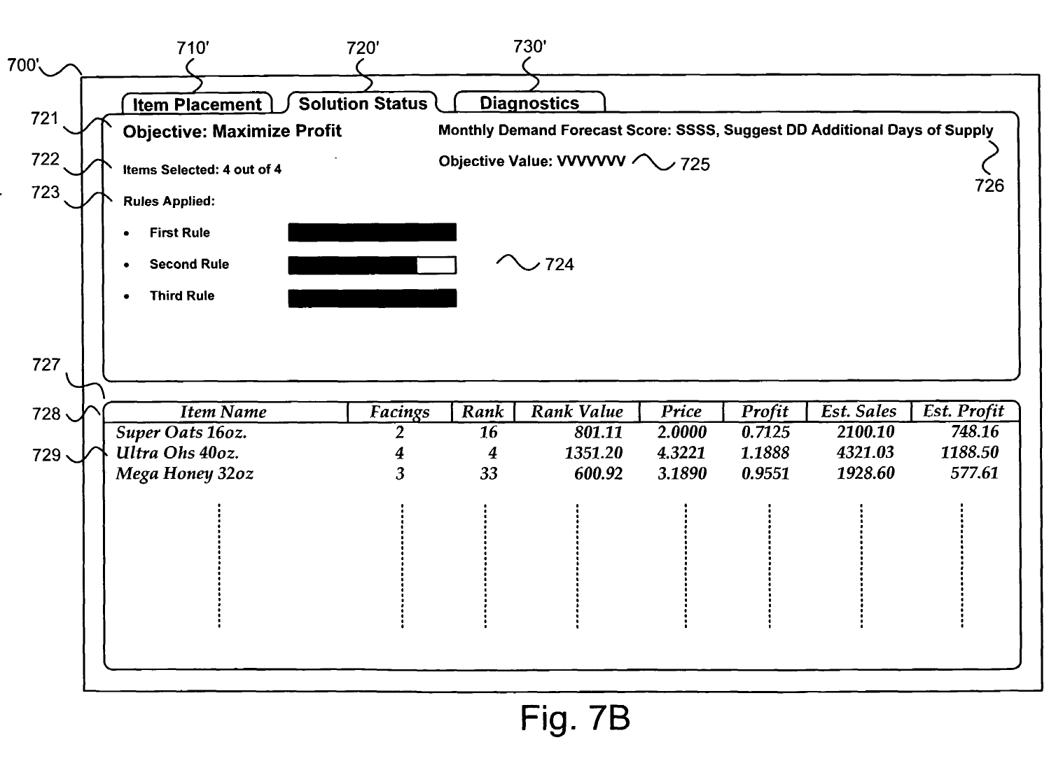

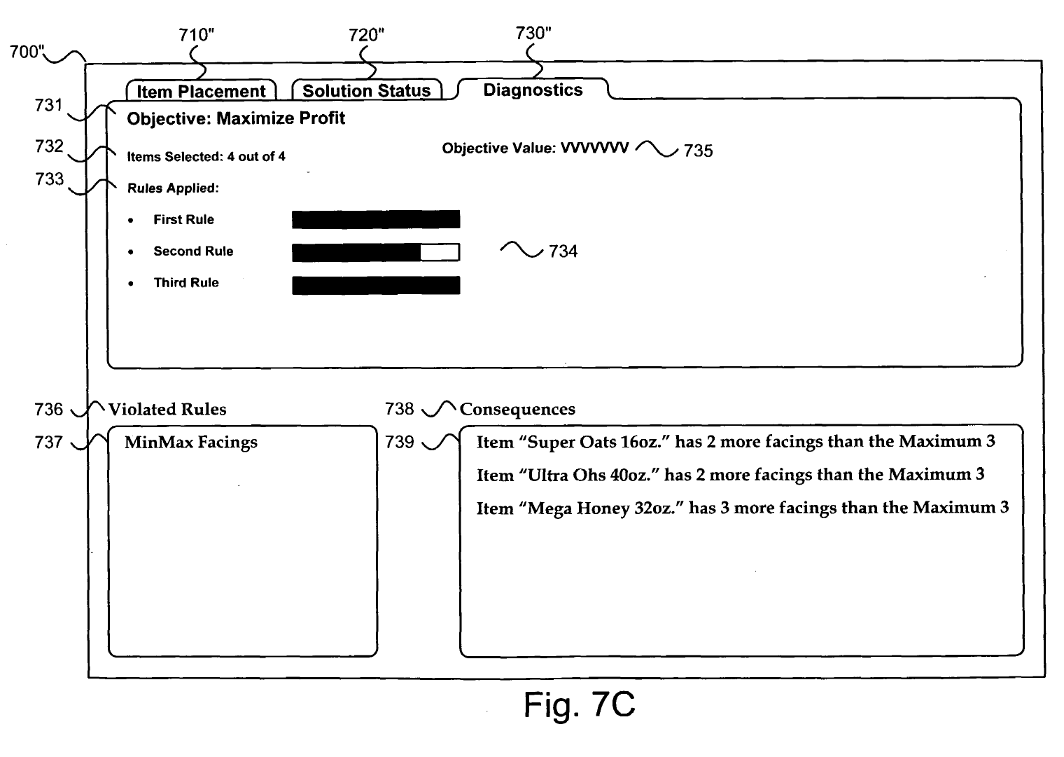

FIGS. 7A-7C are illustrations of a user interface including output visualizations for a retail space management system that is arranged in accordance with the present disclosure. The user interface for this example includes three different views, namely, an item placement view, a solution status view, and a diagnostics view.

FIG. 7A illustrates a user interface view (700) which is activated when the user selects an item placement tab (710). User interface view 700 includes a first region (711) that includes an item image (712) and various other details (713) concerning the selected item such as the item brand, item name, selected shelf for display, selected number of facings for the item, the selected position for display on the shelf, and a precise alignment of the item on the shelf (e.g., XXX inches from left, YYY inches from right). Visualizations are included to show the desired distribution of various items in a defined assortment (in this case four brands) in accordance with a desired objective criteria. The visualizations include a pie chart (714) and a legend (715) for the pie chart, illustrating an objective criteria of 45% Brand A, 25% Brand B, 20% Brand C, and 10% Brand D.

User interface view 700 also includes a graphical depiction of the designed retail shelf space (717) for the current solution, including an illustration of the parameters associated with the shelf (716) such as shelf length. Each illustrated shelf in this example includes room for approximately 12 product facings. The top shelf includes 6 product facings for product Brand A, 3 product facings for product brand B, 2 product facings for product brand C, and 1 product facings for product brand D. A success of 96.9% is achieved for the top shelf as is illustrated by pie chart 718. The bottom shelf includes 5 product facings for product Brand A, 3 product facings for product brand B, 3 product facings for product brand C, and 1 product facings for product brand D. A success of 97.3% is achieved for the bottom shelf as is illustrated by pie chart 719.

FIG. 7B illustrates a user interface view (700′) which is activated when the user selects a solutions status tab (720). User interface view 700′ includes a first region with a title for the current objective (721) of “Maximize Profit”, an indicator of the number of items selected (722), a list of the rules applied (723), a bar chart showing the amount of success achieved for each applied rule (724), an objective value associated with the current solution (725), and a forecast score with additional instruction for a suggested course of action (726). User interface view 700′ also illustrates a table region (727) including a table heading region (728) and item details (729). Item details include any available item detail such as item name, number of facings, rank, rank value, profit, estimated sales, estimated profit, etc.

FIG. 7C illustrates a user interface view (700″) which is activated when the user selects a diagnostics tab (730). User interface view 700″ includes a first region with a title for the current objective (731) of “Maximize Profit”, an indicator of the number of items selected (732), a list of the rules applied (733), a bar chart showing the amount of success achieved for each applied rule (734), and an objective value associated with the current solution (735). User interface view 700″ also illustrates a second region (737) with a heading (736) of “Violated Rules”. Inside of the second region (737) is a list of rules that have been violated (e.g., MinMax Facings). User interface view 700″ also illustrates a third region (739) with a heading (736) of “Consequences”. Inside of the third region (739) is a specific instance of items that violated the rule noted in the second region (737).

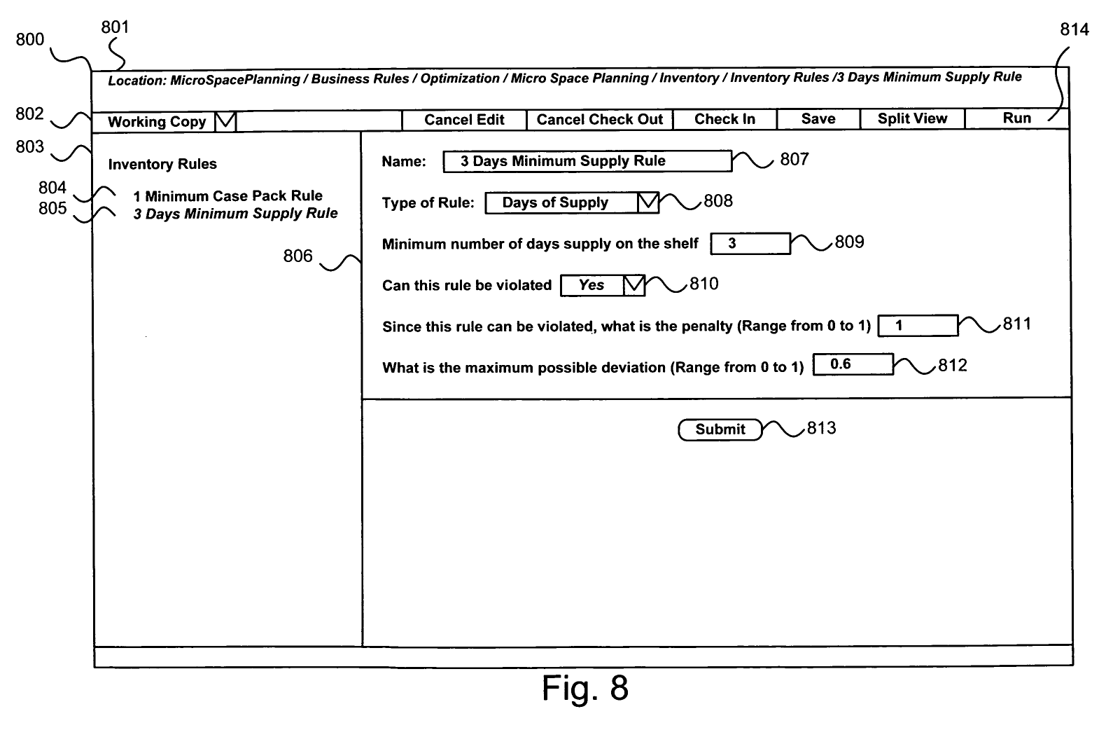

FIG. 8 is an illustration of a user interface (800) including facility for designing or editing inventory rules for a retail space management system that is arranged in accordance with the present disclosure. Although described with reference to inventory rules, the described user interface is equally applicable to other rule definitions such as business rules, assortment rules, blocking rules and item rules.

User interface view 800 includes a designated location (801) associated with the rule to inform the user of the location of the rule within the repository. In this example, the name of the rule is “3 Days Minimum Supply Rule”, and the location of the rule in the repository is designated by “Location: Macro Space Planning/Business Rules/Optimization/Micro Space Planning/Inventory/Inventory Rules/3 Days Minimum Supply Rule.” Region 802 includes a pull down menu for selecting either the master rule template or a working copy (in this case a working copy). Region 803 includes a list of all Inventory Rules that are currently accessible from the repository. In this example, there are two rules (804, 805) that are classified as inventory rules, which are currently accessible form the repository. Rule 804 is titled “1 Minimum Case Pack Rule”, while rule 805 is titled “3 Days Minimum Supply Rule.”

Region 806 corresponds to the template for the currently selected rule. As illustrated, the “3 Days Minimum Supply Rule” includes six fields. The first field (807) corresponds to the name of the rule. The second field (808) corresponds to the type of rule which is designated as “Days of Supply” via a pull-down menu as illustrated. The third field (808) corresponds to a variable associated with this rule, which is this case corresponds to “Minimum number of days supply on shelf” with a value set to 3. The fourth field (810) is a constraint setting for the rule, which is designated as “Can this rule be violated” via a pull-down menu, currently set to Yes.

The fifth field (811) and the sixth field (812) correspond to additional settings associated with the fourth field when the rule can be violated. The fifth field (811) allows the user to enter a penalty factor ranging from 0 to 1 when the rule is violated. The sixth field (812) allows the user to enter the maximum possible deviation from the rule, in this case 0.6. The maximum deviation is contextually related to the variables associated with the rule such as designated by the third field (809). When the optimization engine is unable to achieve a perfect solution to a given scenario, the optimization algorithm will allow this rule to be violated. For the example illustrated in FIG. 8, the variable is a number designating the minimum number of days supply on the shelf as 3, and maximum deviation is 0.6, meaning that a value of 2.4 for this rule will be accepted as a solution to the optimization scenario.

The user interface also includes a user selection button (813) for submitting the modified rule to the system. Once submitted, the rule can be checked for errors. The user interface also includes a set of user selection buttons or links (814) for managing the rule and/or modifying the display region layout. Example buttons or links (814) include “Cancel Edit”, “Cancel Check Out”, “Check In”, “Save”, Split View”, and “Run”. In some instances, a button or link (814) can be used to run a simulation of the rule such as via a “Run” button.

Rules are defined and stored in the repository. Since the repository is shared among many people across the enterprise, safeguard measures must be provided to prevent tampering with rules that are already utilized by other users. As such, each rule in the repository must be “checked out” of the repository when being modified so that no other users in the enterprise can modify the rule at the same time. Once the rule has been modified, the rule can be “check in” to the repository. Region 802 also includes a series of selectable menu choices including “Cancel Edit”, “Cancel Check Out”, “Check In”, “Save”, Split View” and “Run”. Selection of “Cancel Edit” discards any changes made to the current rule. Selection of “Cancel Check Out”

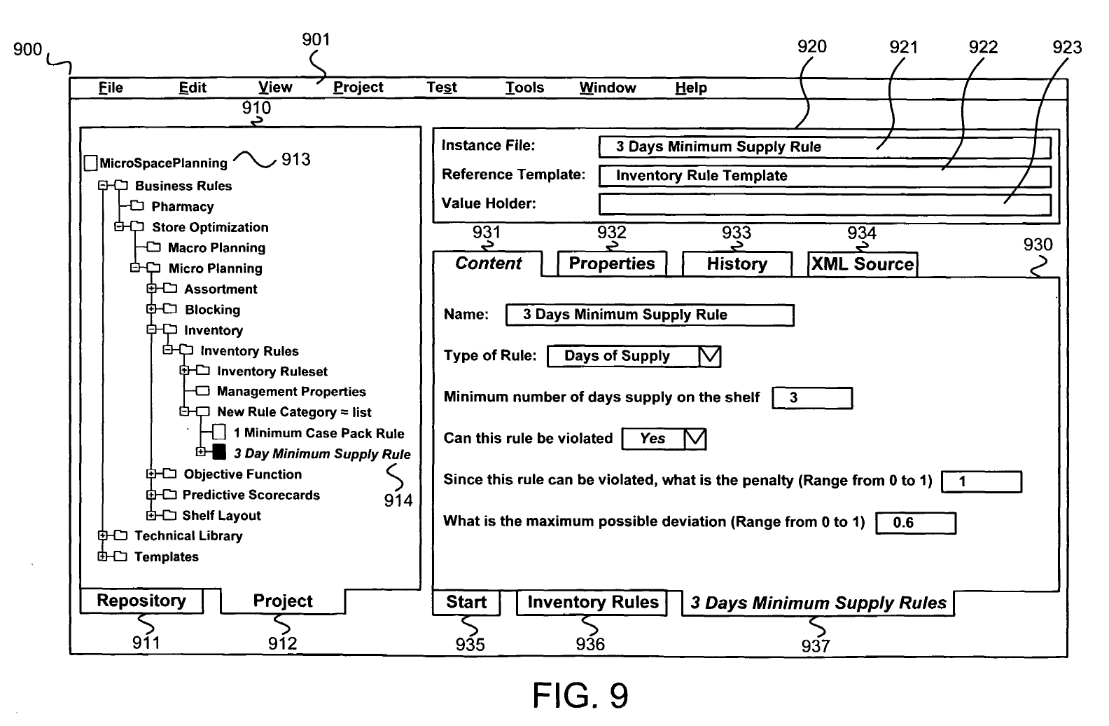

FIG. 9 is an illustration of another user interface (900) including facility for designing inventory rules for a retail space management system that is arranged in accordance with the present disclosure. Although described with reference to inventory rules, the described user interface is equally applicable to other rule definitions such as business rules, assortment rules, blocking rules and item rules.

User interface 900 includes a Toolbar (901), a hierarchical tree view of the currently opened project (910), an instance reference to the currently selected rule (920) in the currently opened project, and a design view for the currently selected rule (930). The toolbar (901) includes file features (File), editing features (Edit), changing the selected view (View), managing projects (Project), testing projects (Test), access to other tools (Tools), manipulating windows (Window), and help (Help).

The hierarchical tree view (910) corresponds to either a repository view or a project view, which are accessible via their corresponding tabs (911, 912). The hierarchical view (910) provides a graphical illustration of all rules, functions, templates, and other features that are used by a given project. For example, the currently selected rule (914) for “3 Days Minimum Supply Rule” is part of the project titled MicroSpacePlanning (913), through the path: MicroSpacePlanning\Business Rules\Store Optimization\Micro Planning\Inventory\Inventory Rules\New Rule Category\3 Das Minimum Supply Rule.

The instance reference for the currently selected rule (920) includes three fields, namely an instance name field (921), a reference template field (922), and a value holder field (922). The instance name field (921) includes a text name for the current rule that is being edited. The reference template field (922) is a reference to the master template that the rule is based from. The value holder field (923) is a field for entering values. The design view (930) includes multiple views that are selected via tabs for content (931), properties (932), history (933) and XML source (934). The design view includes three additional tabs, one for selecting start (935), one for selecting inventory rules (936), and one for the specific rule once opened (937).

The content tab for the design view (930) selects a view that is substantially the same content as that previously described for region 806 of FIG. 8. The properties tab (932) selects a view of properties associated with the current rule. The history tab (933) selects a view that describes the history of revisions and changes to the currently selected rule. The XML Source tab (934) selects a view that corresponds to the XML source code for the current rule, including the design of the user interface that is accessible once the rule is checked into the repository.

Complete rule tracking and version control is implemented in the system, where the check in and check out procedures are used to manage unique instances of each rule. The system tracks the changes to rules over time, allowing the user to access past versions and allowing the user to audit the rule to determine who made changes to the rule over time (e.g., using the history tab on the design view).

The system further manages properties to organize, track and find components of rule projects such as via the hierarchical view (910) and the properties tab (932). Standard queries can be used in the user interface tools to locate rules, properties, etc. Customized searches can also be conducted through the various tools.

Management of rules over time is simplified by allowing the easy specification of rules management templates. Each template governs what may be changed in the rule, what values are allowed, and how the template should be displayed to the user. With the push of a button, the system automatically generates entire multi-page Web-based Rule Maintenance Applications that allow non-technical business users to review and alter rules within the guidelines of the underlying templates.

The presently disclosed invention enables users from varied perspectives to access rules, templates, and other features from a common shared repository. A business rule engine is used in conjunction with an optimization engine to permit users to interact with the optimization models used by the optimization engine. Business analysts and retail space planners both have access to the repository to develop models, modify models, and develop various rules that can be used by the optimization engine. The optimization engine used in conjunction with the developed rules and models to provide what-if analysis to assist retailers in solving space planning needs.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A system for managing retail space, comprising:
a data source that is arranged to store item definitions and historical data;
a repository that is arranged to store business rules, templates, and models;
a user interface that is arranged to facilitate the organization of a project by selecting a combination of instances of business rules, templates, and models that are retrieved from the repository, specifying data for retrieval from the data source for use with a scenario for the project, and selection of an optimization objective for the scenario of the project; and
an optimization engine that is arranged to access the specified data from the data source, evaluate the scenario for a project, and find a solution to the scenario for the project using the data from the specified data in accordance with the selected optimization objective.

2. The system of claim 1, wherein the item definitions comprise one of an item name, an item brand, an item size, an item dimensions, an item weight, an item image, an item cost, an item MSRP, an item category, an item sub-category, and an item case pack requirement.

3. The system of claim 1, wherein the historical data comprise one of past sales data by item, past sales data by category, past sales data by sub-category, past sales data by profits, past sales data by losses, future sales data by item, future sales data by category, future sales data by sub-category, future sales data by predicted profits, future sales data by predicted losses, past inventory data by item, past inventory data by category, and past inventory data by sub-category.

4. The system of claim 1, wherein the data source is further arranged to store planning data.

5. The system of claim 4, wherein the planning data comprises one of retail space dimensions by store, retails aisle requirements by store, retail space requirements for fixtures, and template definitions.

6. The system of claim 1, wherein the repository is further arranged to store each instance of each rule along with a history of modification to each rule.

7. The system of claim 1, wherein the user interface is further arranged to select constraints associated with at least one instance of the business rules selected for the project.

8. The system of claim 1, wherein the user interface is further arranged to select constraints associated with at least one instance of the business rules selected for the project.

9. The system of claim 1, wherein the user interface is further arranged to select constraints associated with at least one model selected for the project such that the logical output of the model is limited by the selected constraints.

10. The system of claim 1, wherein the user interface is further arranged to select parameters associated with at least one instance of the business rules selected for the project, wherein the at least one instance of the business is associated with a physical boundary in the retail space that is limited by the parameter.

11. The system of claim 1, wherein the user interface is further arranged to automatically generate a plan-o-gram for the solution to the scenario for the project that was found by the optimization engine.

12. The system of claim 1, wherein the user interface is further arranged to automatically generate a plan-o-gram for the solution that was found by the optimization engine.

13. The system of claim 1, wherein the user interface is further arranged to automatically generate a scorecard for the solution that was found by the optimization engine, wherein the scorecard includes a score that indicates the percentage of optimization objectives that were satisfied in finding the solution.

14. The system of claim 13, wherein the user interface is further arranged such that the scorecard includes another score that indicates the percentage of optimization objectives that failed to be satisfied in finding the solution.

16. The system of claim 1, wherein the user interface is further arranged to automatically generate a graphical chart indicative of the solution found by the optimization engine for the scenario, wherein the graphical chart comprises one of a pie chart, a bar chart, and a graph.

17. The system of claim 1, wherein each instance of business rule selected by the user interface comprises one of an assortment rule, an inventory rule, and a blocking rule.

18. The system of claim 17, wherein the assortment rule is arranged to define one of complementary products, ranking criteria for products based on sales, ranking criteria products based on profits, inventory coverage, private label coverage, and an assortment decision tree to establish hierarchies for products.

19. The system of claim 17, wherein the inventory rule is arranged to define one of case pack requirements for products, days of supply requirements for products, minimum number of product facings for products, maximum number of facings for products, and conflict resolution criteria for conflicting inventory rules.

20. The system of claim 17, wherein the blocking rule is arranged to define one of brand blocking and item affinity.

21. The system of claim 1, wherein the user interface is further arranged for selection of pre-assortment rules, and wherein the optimization engine is further arranged to process the pre-assortment rules to identify rankings associated with the assortment.

22. The system of claim 1, wherein the user interface is further arranged to select a business rule for the project that can be violated, and wherein the optimization engine is arranged to automatically relax the requirements for the selected business rule that can be violated when the solution to the scenario cannot otherwise be found for the selected optimization objective.

23. The system of claim 1, further comprising a parser that is arranged to receive data from an external data source and format the received data for storage in the data source.

24. The system of claim 1, further comprising a parser that is arranged to identify variables and interface parameters associated with business rules, models and templates stored in the repository.

25. The system of claim 1, further comprising a parser that is arranged to parse methods and model definitions into linear programs.

26. The system of claim 1, further comprising a parser that is arranged to evaluate mathematical models and rules and translate the mathematical models and rules into a language that is acceptable by the optimization engine.

27. A computer implemented method for managing retail space, comprising:
accessing data from a source that includes stored therein item definitions and historical data;
selecting a scenario for a base model with a user interface, wherein the scenario defines either a constraint or a parameter for a business rule associated with the base model;
selecting an optimization objective for the scenario with the user interface;
building an instance of the base model based on available data sources, wherein the instance of the base model includes decision variables, parameters, constraints, and functions;
finding a solution to the scenario for the optimization objective with an optimization engine; and
generating a visualization for the solution to the scenario for displaying with the user interface.

28. The computer implemented method of claim 27, wherein building the instance of the base model comprises:
retrieving a core model from a repository;
creating decision variables for the core model;
evaluating data in the data source; and
building the model instance based on the data that is available in the data source.

29. The computer implemented method of claim 28, wherein building the instance of the base model further comprises creating parameters for the model instance, wherein the parameters are associated with a physical boundary in the retail space that is limited by the parameters.

30. The computer implemented method of claim 28, wherein building the instance of the base model further comprises defining inventory constraints for the model instance.

31. The computer implemented method of claim 28, wherein building the instance of the base model further comprises defining assortment constraints for the model instance.

32. The computer implemented method of claim 28, wherein building the instance of the base model further comprises defining blocking constraints for the model instance.

33. The computer implemented method of claim 28, wherein building the instance of the base model further comprises creating an objective function for goals associated with model instance.

34. The computer implemented method of claim 27, wherein the generated visualization for the user interface corresponds to a plan-o-gram for the solution to the scenario that was found by the optimization engine.

35. The computer implemented method of claim 27, wherein the generated visualization for the user interface corresponds to a scorecard for the solution to the scenario that was found by the optimization engine, wherein the scorecard includes a score that indicates the percentage of optimization objectives that were satisfied in finding the solution.

36. The computer implemented method of claim 27, wherein the generated visualization for the user interface corresponds to a graphical chart indicative of the solution found by the optimization engine for the scenario, wherein the graphical chart comprises one of a pie chart, a bar chart, and a graph.

37. The computer implemented method of claim 27, further comprising: selecting a business rule associated with the model instance that can be violated, and allowing the optimization engine is automatically relax the requirements for the selected business rule that can be violated when the solution to the scenario cannot otherwise be found for the selected optimization objective.

38. The computer implemented method of claim 27, wherein finding a solution to the scenario for the optimization objective comprises:
applying constraints and the optimization objectives to the instance of the base model;
initializing variables for the instance of the base model; and
applying an optimization method to the initialized instance of the base mode with the optimization engine.

39. The computer implemented method of claim 38, wherein finding a solution to the scenario for the optimization objective further comprises validating the applied constraints and optimization objectives for the instance of the base model, and generating an error report for the user interface when either the constraints or the optimization objectives fail validation.

40. The computer implemented method of claim 38, wherein finding a solution to the scenario for the optimization objective further comprises evaluating solutions found from the applied optimization method, repeatedly relaxing the constraints and applying the optimization method when the solution found is unacceptable.
